(19) United States
(12) Patent Application Publication
(10) Pub. No.: US 2022/0033188 A1
(43) Pub. Date: Feb. 3, 2022

(54) STORAGE SYSTEM AND/OR PRODUCTION SYSTEM HAVING AT LEAST ONE HANDLING DEVICE

(71) Applicant: Liebherr-Verzahntechnik GmbH, Kempten (DE)

(72) Inventors: Markus ZOLLITSCH, Haldenwang (DE); Nicolai FRIEDBERGER, Sonthofen (DE); Herbert GUGGEMOS, Untrasried (DE); Florian HOESSLE, Immenstadt (DE)

(21) Appl. No.: 17/343,657

(22) Filed: Jun. 9, 2021

(30) Foreign Application Priority Data
Jun. 16, 2020 (DE) 10 2020 115 816.5

(51) Int. Cl. B65G 1/137

(52) U.S. Cl. CPC B65G 1/1376

(57) ABSTRACT

The disclosure relates to a system having a handling device which is a rail-bound vehicle having a travel unit movable in a longitudinal direction of the system or a handling device fixed at a location with a travel unit movable about its own axis, a lifting unit of a stacker crane movable in a vertical direction, and a load receiving unit which can be movable and/or rotatable in a transverse direction, wherein the load receiving unit has an interface for fastening a lifting tool that is configured such that the lifting tool or a part of the lifting tool can be automatically changed or removed, with the handling device having a releasable latching device in whose closed state the lifting tool or its changeable part is secured against loss.

### CROSS REFERENCE TO RELATED APPLICATIONS

The present application claims priority to German Patent Application No. 10 2020 115 816.5 filed on Jun. 16, 2020. The entire contents of the above-listed application is hereby incorporated by reference for all purposes.

### TECHNICAL FIELD

The disclosure relates to a storage system and/or production system having a handling device with a lifting tool for the manipulation of workpiece holders.

### BACKGROUND

Storage systems and/or production systems are automation solutions, for example, for the production, the machining, or the assembly of workpieces. Solutions for the automatic temporary storage of workpieces, workpiece holders, or tools are typically called storage systems. In the simplest sense, solutions for the automated supply of one or more machining stations, for example the automatic loading and unloading of a machine with workpieces, workpiece holders, or tools, are understood as production systems. In this respect, storage systems and production systems are automation solutions for both intermediate storage and production supply.

### SUMMARY

Known handling systems for the manipulation of workpiece holders in a storage system and/or production system, for example, comprise stacker cranes (STCs). Large storage systems and/or production systems are here frequently rail-bound vehicles for the manipulation of workpiece holders such as pallets, in a storage system and/or for loading and unloading machine tools and setup stations of a production system. The movement of a stacker crane typically takes place in three axes, namely in the longitudinal aisle direction of the storage system using the so-called travel unit of the stacker crane, in the vertical direction using the so-called lifting unit of the stacker crane, and in the transverse aisle direction using the load receiving unit of the stacker crane. Stacker cranes are typically fixed at one location in small storage systems and/or production systems. The stacker crane is typically arranged centrally between the further components of the storage system and/or production system, with the further components being able to comprise, for example, shelves, setup stations, or machines. The stacker crane can thereby typically manipulate the workpiece holders at the further components of the storage system and/or production system by movement in three axes, namely by a rotational movement of the travel unit of the stacker crane about its own axis, in the vertical direction using the so-called lifting unit of the stacker crane, and in the transverse direction using the load receiving unit of the stacker crane. The load receiving unit comprises a lifting tool in the form of, for example, a fork having two prongs. A handling device of the category is disclosed, for example, in EP 3 272 697 A1.

There are a plurality of machine pallets and material pallets that differ in form from one another due to the machine manufacturer and/or on the basis of individual machine or workpiece properties. It can thus occur on the connection of different machines and/or workpieces, with their respective individual machine pallets and/or workpiece pallets, to form a storage system and/or production system that the respective machine pallets and/or workpiece pallets cannot be handled by a single unchangeable lifting tool.

An obvious solution of this problem is the design of a pallet or of a general workpiece holder for the storage and/or production system, which represents a compromise between the different demands of machines and/or workpieces of a storage system and/or production system. However, the productivity of the storage system and/or production system usually suffers therefrom. A further disadvantage of this solution approach is that a pallet or a general workpiece holder cannot always be designed for the storage system and/or production system. Another approach known in the prior art is the use of attachment pallets in the machine tools of a production system. In this case, however, machine pallets remaining in the machine tool have to be adapted, which can result in additional costs. The storage system and/or production system can furthermore be divided into two separate systems, which is, however, as a rule associated with significant additional costs since a large number of components are required in duplicate.

To be able to handle workpiece holders or pallets of different constructions within the same storage system and/or production system, handling devices have already become known having a fork with two prongs in which the distance between the prongs can be adjusted. This solution, that is elegant per se, is however, only suitable for those systems in which the pallets to be handled only differ in their widths. If, however, not only forks having differently spaced apart prongs are required for the handling of the different pallets, but also generally different lifting tools such as forks having different prong lengths or having receiving pins, said solution does not provide any remedy.

It is the object of the disclosure to provide a storage system and/or production system and a corresponding handling device by which said disadvantages of the prior art are overcome.

Against this background, the disclosure relates to a storage system and/or production system having at least one handling device for the manipulation of workpiece holders, wherein the handling device is a rail-bound vehicle having a travel unit movable in a longitudinal direction of the system or a handling device fixed at the location and rotating about its own axis, having a lifting unit of the stacker crane movable in the vertical direction, and having a load receiving unit, which in some embodiments can be movable and/or rotatable in the transverse direction, wherein the load receiving device has a lifting tool, wherein the load receiving unit has an interface for the fastening of the lifting tool that is configured such that the lifting tool or a part of the lifting tool can be automatically changed or removed, wherein the handling device has a releasable latching device in whose closed state the lifting tool or its changeable part are secured against loss, and wherein the storage system and/or production system or the handling device has at least one storage space or placement station for lifting tools at which the releasable latching device of the handling device can be switched from a closed state to an open state and vice versa.

Provision is made in accordance with the disclosure that the loading receiving unit has an interface for fastening the lifting tool that is configured such that the lifting tool or a part of the lifting tool can be automatically changed or removed. The handling device has a releasable latching device for this purpose that secures the lifting tool or its changeable part against loss in the closed state. In addition, at least one storage space for lifting tools is provided in the storage system and/or production system at which the releasable latching device of the handling device can be switched from a closed state into an open state and vice versa.

In some embodiments, the handling device may be a stacker crane (STC). It serves the manipulation of workpiece holders such as pallets in a storage system and/or for loading and unloading machine tools and setup stations of a combined storage system and/or production system. The lifting tool coupled to the load receiving unit may be a fork having two prongs.

Only some part of the lifting tool can be changed in an embodiment of the disclosure. Individual prongs of a fork having two or more than two prongs can be removed or changed, for example.

In an embodiment the interface and the lifting tool or its changeable part may be secured against loss so that the lifting tool cannot release by accident after a collision with other components of the system, for instance, or cannot change its position or orientation at the handling device. Different latching devices can be provided for the securing that can work on a pneumatic, hydraulic, mechanical, or electrical basis or on a combined basis.

In an embodiment, the handling device comprises an actuating device that is configured to move the latching device from a closed state into an open state in which the lifting tool or its changeable part is no longer secured against loss. In some embodiments, the actuation device can be configured as a mechanical actuation device.

In an embodiment, the handling device comprises at least one sensor for determining the presence or the position of the lifting tool at the load receiving unit or at a specific interface. A plurality of sensors can be combined in a sensor array. The or a sensor or the or some sensors can additionally or alternatively be configured to monitor the state of the latching mechanism and/or to identify the coupled lifting tool or the coupled lifting tool part.

The sensors and/or the actuation device can be in signal communication with a control unit of the handling device or, with the aid of a corresponding interface, with a control unit of the system.

In an embodiment, the handling device comprises two or more load receiving units each having an interface as described or the load receiving unit comprises two or more interfaces as described. In this embodiment, the handling device is consequently configured as a double loader or multi-loader.

Against the initially named background, the disclosure further relates to a storage system and/or production system having at least one handling device in accordance with the disclosure and having a changing station that comprises at least one storage space for the changeable lifting tool of the handling device or its changeable part.

The changeable lifting tool or the changeable parts can be placed down and picked up automatically at the storage space by the handling device.

The changing station may comprise at least two storage spaces. A storage space can respectively receive a lifting tool or a lifting tool part so that a lifting tool or a lifting tool part of a first kind can be stored at a first storage space and a lifting tool or a lifting tool part of a second kind can be stored at a different storage space. The storages spaces can be arranged collected at a location within the system or can be distributed over the system.

The changing station or individual storage spaces of the changing station can be present as independent stations within the system or can be integrated in other components of the system, such as in stacks, setup stations, or machine tools.

The number of storage spaces can correspond to at least the number of lifting tools or lifting tool parts required for the operation of the system.

Alternatively or additionally to the storage spaces, at least one placement station for the lifting tools can be provided on the handling device. Any surface on which the lifting tools can be placed is generally suitable as a placement station. In accordance with an embodiment, the surface of an oil pan provided on the handling device can here serve as a placement station. Alternatively, the placement station on the oil pan of the handling device is formed as a storage space.

A lifting tool can be placed down at the storage spaces and removed therefrom by traveling the handling device or the load receiving unit of the handling device in the X direction, Y direction, and/or Z direction of the system. The device can be traveled in every direction on the placing down; but all the degrees of freedom are not used for some procedures depending on the design of the device and of the stacks.

The storage spaces can have positioning aids for lifting tools placed thereon, for example center pins or rails.

In an embodiment, the storage places have an actuation device that is configured to change a latching device formed at the handling device from a closed state in which the lifting tool or its changeable part is secured against loss into an open state in which the lifting tool or its changeable part is no longer secured against loss. A latching device can thus be released at the handling device at the storage space or only at the storage space. In certain embodiments, the actuation device may be configured as a mechanical actuation device.

Alternatively, the actuation device can also be located at the handling device, for example, at the load receiving unit.

In an embodiment, the storage spaces have at least one sensor and an interface for transferring a sensor signal to a control unit of the handling device or of the system. A plurality of sensors can be combined in a sensor array. The sensor or sensors can be configured to recognize the occupation of the storage space with a lifting tool or lifting tool part, the position of the lifting tool or of the lifting tool part at the storage space, and/or the kind of lifting tool or lifting tool part located at the storage space.

The handling device or the system can be configured such that a latching device for the lifting tool or a lifting tool part at the handling device is released or latched in response to a signal from sensors of the storage space and/or from sensors at the handling device. A signal can, for example, be transmitted to the control unit on the placing down of the lifting tool or of the lifting tool part at the storage space as soon as the lifting tool or the lifting tool part is correctly positioned. As a result, the control unit can transmit a signal to release the latching to an actuation device.

Alternatively, the actuation device can also be controlled independently of sensor signals and purely on the basis of a preprogrammed routine.

A plurality of workpiece holders, for instance, a plurality of pallets of at least two different types A and B, can be handled using a handling device in accordance with the disclosure or of a system in accordance with the disclosure. Workpiece holders of type A cannot be handled with the same lifting tool as workpiece holders of type B. Two types A′ and B′ of lifting tools are therefore required, with a lifting tool of type A′ being able to handle a tool holder of type A and a lifting tool of type B′ being able to handle a workpiece holder of type B. If the handling device is equipped with a lifting tool of type A′, but a workpiece holder of type B is to be handled, the handling device travels to a storage space of the changing station and automatically places the lifting tool of type A down. The handling device then travels to a different storage space of the changing station and automatically picks up the lifting tool of type B′ there. As a result, the handling device can then manipulate the workpiece holder of type B.

### BRIEF DESCRIPTION OF THE FIGURES

Further details of the disclosure result from the following embodiment described with reference to the Figures. There are shown in the Figures:

FIG. 1: a first embodiment of a storage system and/or production system in accordance with the disclosure;

FIG. 2: a second embodiment of a storage system and/or production system in accordance with the disclosure;

FIG. 3: a third embodiment of a storage system and/or production system in accordance with the disclosure;

FIGS. 4a-4d: a handling device of such systems equipped with different lifting tools;

FIG. 5: a side view of a shelf having storage spaces of a changing station;

FIGS. 6a-6b: views of a first embodiment of such a storage space;

FIG. 7: a side view of a second embodiment of such a storage space;

FIGS. 8a-8b: views of a fastening region of a lifting tool at the handling device in an embodiment;

FIGS. 9a-9c: a process to place down a lifting tool fastened as in FIGS. 7a-b at a storage space as shown in FIG. 5;

FIGS. 10a-10c: views of a fastening region of a lifting tool at the handling device in a different embodiment;

FIGS. 11a-11b: views of a fastening region of a lifting tool at the handling device in yet another embodiment. and

FIG. 12: an alternative embodiment of a handling device having an integrated placement station for receiving lifting tools.

### DETAILED DESCRIPTION

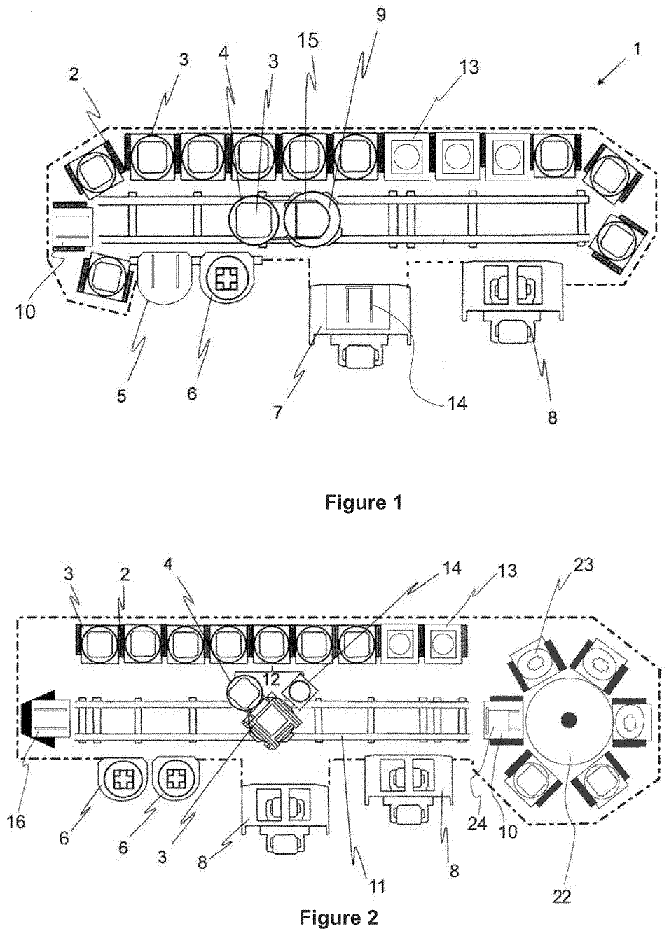

Respective views of different embodiments of storage systems and/or production systems 1 in accordance with the disclosure are shown in a bird's eye view in FIGS. 1 and 2.

System 1 in both embodiments comprises a plurality of stacks 2 and 10 having compartments for storing pallets 3, 13, and 23, two setup stations 5 and 6, and two machine tools 7 and 8. The stacks 2 and 10, the setup stations 5 and 6, and the machine tools 7 and 8 are arranged at both sides of an aisle in which a handling device 9 in accordance with the disclosure is located that can be traveled along rails 11 in the longitudinal direction of the aisle.

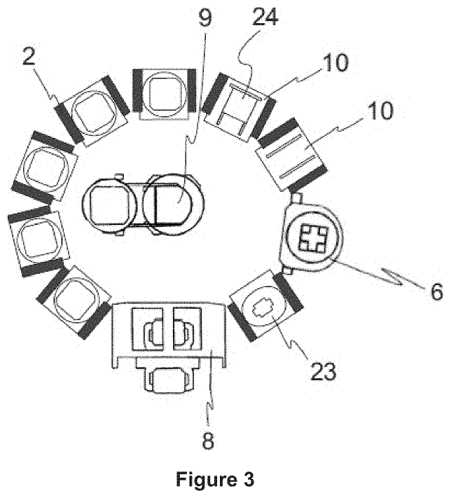

The handling device 9 is configured in accordance with the disclosure such that the lifting tools 4, 12, 14, and 24 are releasably fastened to an interface 15 of the handling device 9 and can be automatically changed. FIGS. 3a-3d show views of the handling device 9 equipped with different lifting tools 4, 13, 14, and 24 from a bird's eye view.

The stacks 2 are regular stacks having storage compartments for receiving pallets 3 of a first type A and pallets 13 of a second type B. The pallets 3 and 13 serve as holders for workpieces and tools. The stacks 10 additionally comprise storage spaces 17 and 18 for changeable lifting tools 4, 12, 14, 24 of the handling device 9 and thus represent a part of a changing station of the system 1.

The setup station 6 is a regular setup station and the machine tool 8 is a regular machine tool, while setup station 5 and machine tool 7 additionally have storage spaces 17 and 18 for changeable lifting tools 4, 12, 14 24 of the handling device 9 and thus likewise represent a part of the changing station of the system 1.

The embodiment of FIG. 2 differs from the embodiment in accordance with FIG. 1, apart from some minor differences in the layout of the individual devices and stations, to the extent that the handling device 9 is there formed as a double loader and has a design rotatable about a vertical axis and having two load receiving units that each have an interface 15 for fastening lifting tools 4, 12, 14, 24. In the embodiment of FIG. 2, a rotatable stack arrangement 22 is furthermore arranged at one end of the aisle and the storage capacity of the system can be increased by it, pallets 3 having workpieces can be transferred to a further system at it, and lifting tools 4, 12, 14, 24 can be introduced into or removed from the system 1 at it.

The embodiment of FIG. 3 shows the storage system and/or production system with a handling device fixed at the location and a travel unit, with the travel unit permitting a rotational movement about its own axis. In this respect, the individual devices such as stacks 2, setup stations 6, and machine tools 8 are arranged around the handling device 9. The individual devices can thereby be reached by the stacker crane due to the rotational movement of the travel unit and the further movements by the lifting unit and the load receiving unit. The devices are arranged in circular form around the handling device 9 in FIG. 3. The devices can, however, also be arranged in oval shape or in other geometrical shapes around the crane stacker.

A stack 10 equipped with additional storage spaces 17 and 18 for changeable lifting tools 4, 12, 14, 24 of the handling device 9 is shown in more detail in the side view of FIG. 5. The upper two compartments of the stack 10 serve the placing down of a pallet 3 having workpieces, while the lower two compartments are configured as storage spaces 17 and 18 for changeable lifting tools 4, 12, 14, 24 of the handling device 9.

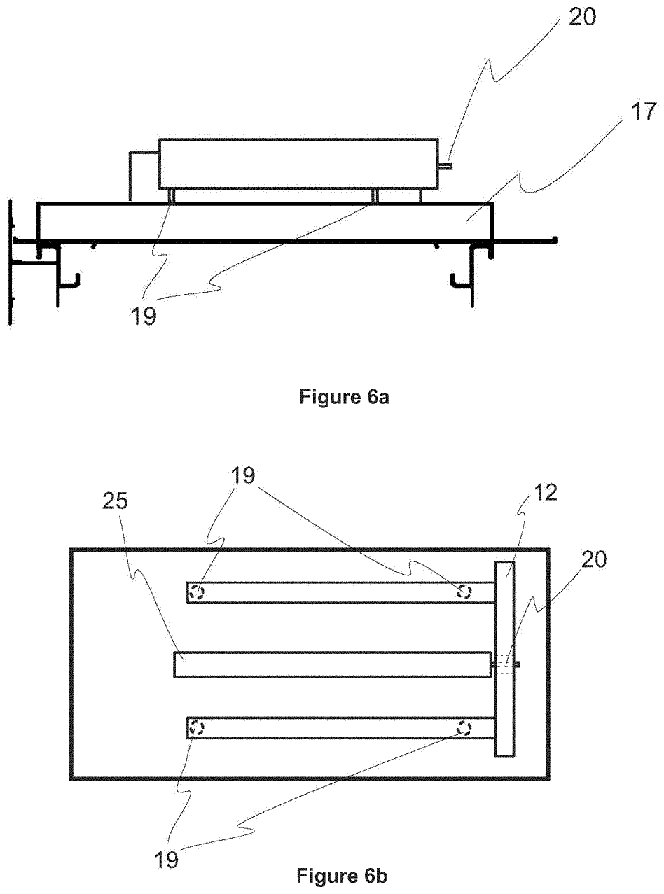

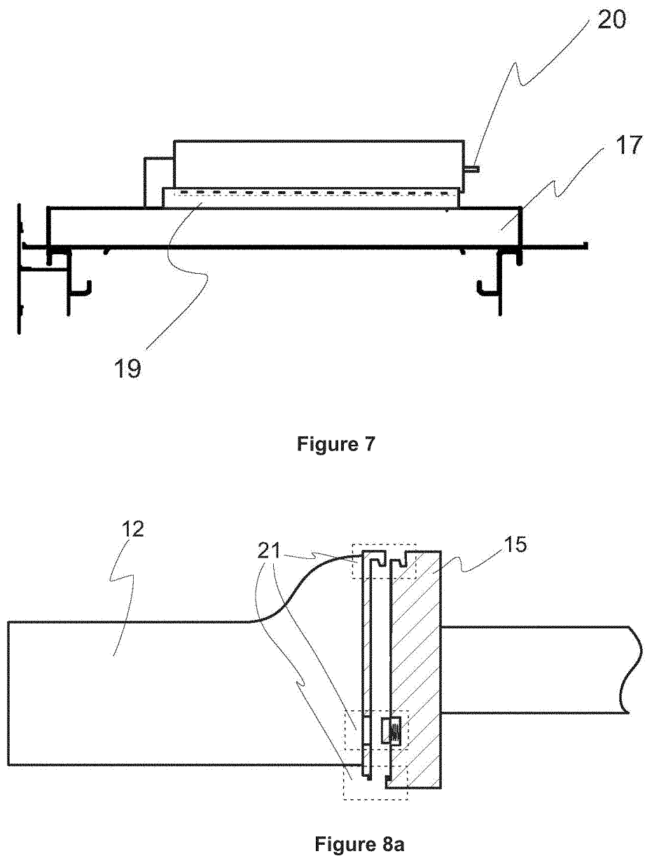

Two variants of a storage space 17 are shown in FIGS. 6a-6b and in FIG. 7. The variants differ in the types of the positioning aids 19 for the lifting tools 4, 12, 14, 24. In the variant in accordance with FIGS. 6a-6b, the positioning aids 19 are configured in the form of vertical center pins. In the variant in accordance with FIG. 7, the positioning aids 19 are configured in the form of rails extending in the depth direction of the storage space 17. In both variants, the storage space 17 comprises an actuation device 20 in the form of a frontally projecting pressure pin to release and latch a latching mechanism 21 formed at the handling device 9 for holding a lifting tool 4, 12, 14, 24, as will be described even more specifically below. Both variants of the storage space 17 furthermore comprise a sensor array 25 (only recognizable in the plan view of FIG. 5b) to be able to recognize an occupation of the storage space 17 with a lifting tool 4 12, 14, 24 and a correct positioning of the lifting tool 4, 12, 14, 24 on the storage space 17.

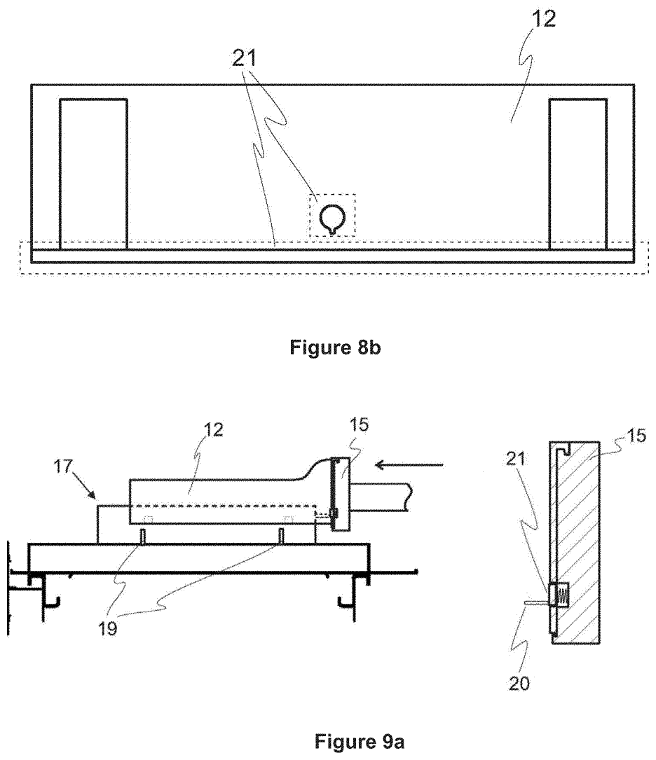

FIGS. 8a-8b show side views and frontal views of an embodiment of the interface 15 of the handling device 9 and of a crossbar of the lifting tool 12. The fastening and the latching mechanism 21 can be easily recognized in these Figures.

The interface 15 of the handling device 9 at the top and at the bottom respective notches extending in the transverse direction and open to the top. Corresponding webs arranged at the top and at the bottom at the crossbar of the lifting tool 12 and directed to the bottom are seated in these two notches. The lifting tool 12 is secured by this shape matched connection against a release from the handling device 9 to the bottom and to the front as well as against a downwardly directed tilt movement. So that the lifting tool 12 cannot unintentionally release from the handling device 9 after an incident such as a collision with other components of the system 1 in that it is shifted upward or is tilted upward, the interface 15 furthermore comprises a spring loaded plunger that is preloaded toward a latching position in which it projects to the front over the plane of the interface 15, corresponding to the support plane for the lifting tool 12. A corresponding cutout into which the plunger engages is arranged at the crossbar of the lifting tool 12. The lifting tool 12 is fixed to the interface 15 in this manner. The corresponding notches and webs and the plunger and the cutout together form a fastening and simultaneously a latching mechanism 21 whose function will be explained in more detail in the following.

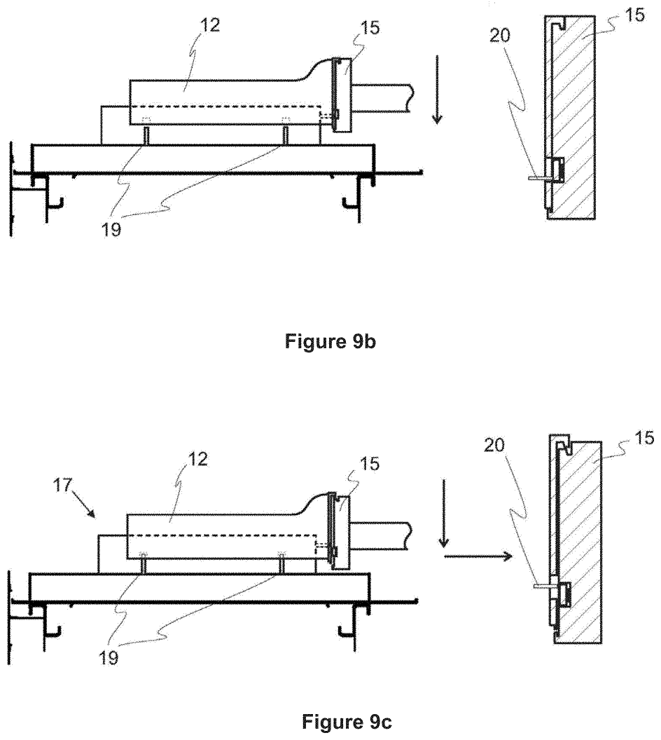

A procedure for storing a lifting tool 12 that is configured as shown in FIGS. 8a-8b and that is fastened to the handling device 9 is shown in FIGS. 9a-9c at a storage place 17 as shown in FIGS. 6a-6b. A respective total view is shown on the left side of the Figures; a schematic detail view of the fastening region of the lifting tool 12 at the handling device 9 on the right side.

As can be recognized in FIG. 8a, the lifting tool 12 fastened as shown in FIGS. 8a-8b to the interface 15 of the handling device 9 can be moved translatorily in the direction of the arrow over the storage space 17. The incoming height is selected here such that the pressure pin of the actuation device 20 of the storage space 17 impacts the plunger of the latching mechanism 21 from the front in the last phase of the horizontal incoming movement and presses it against the preload of the spring out of the cutout in the crossbar of the lifting tool 12 into the interface 15.

This can easily be recognized in the right illustration of FIG. 9b. Instead of the plunger of the latching mechanism 21, the pressure pin of the actuation device 20 now engages into the cutout in the crossbar of the lifting tool 12. Since the pressure pin has a considerably smaller vertical extent than the plunger, as can easily be recognized in FIG. 8b, and since the lifting tool can therefore be moved in this state upward relative to the interface, the lifting tool 12 is released in the last phase of the incoming movement.

Once the lifting tool 12 has thus been correctly positioned above the storage place 17, it is traveled downwardly in the direction of the arrow, as is shown in the left illustration of FIG. 8b, until the vertical center pins of the positioning aids 19 engage in corresponding holes at the lower side of the lifting tool and contact the bottom of these holes.

If then the handling device 9 travels the interface 15 even further downward, as is shown in FIG. 9c, the webs of the crossbar of the lifting tool 12 are raised from the notches of the interface 15 and the lifting tool is thus released from the interface 15. The interface 15 can be moved back without the lifting tool 12.

The process shown in FIGS. 9a-9c can be reversed to equip the handling device 9 with lifting tools 4, 12, 14, 24.

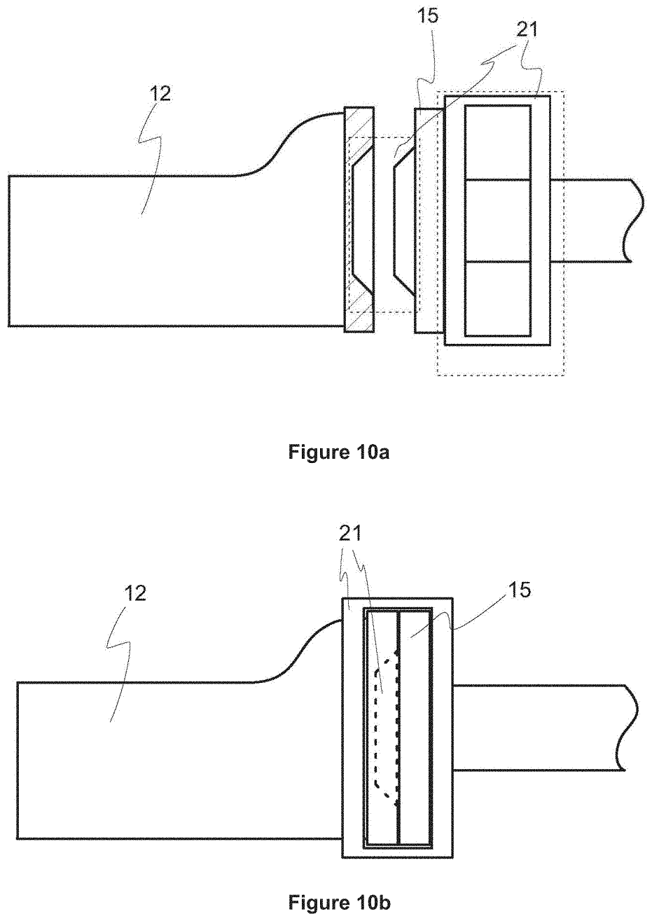

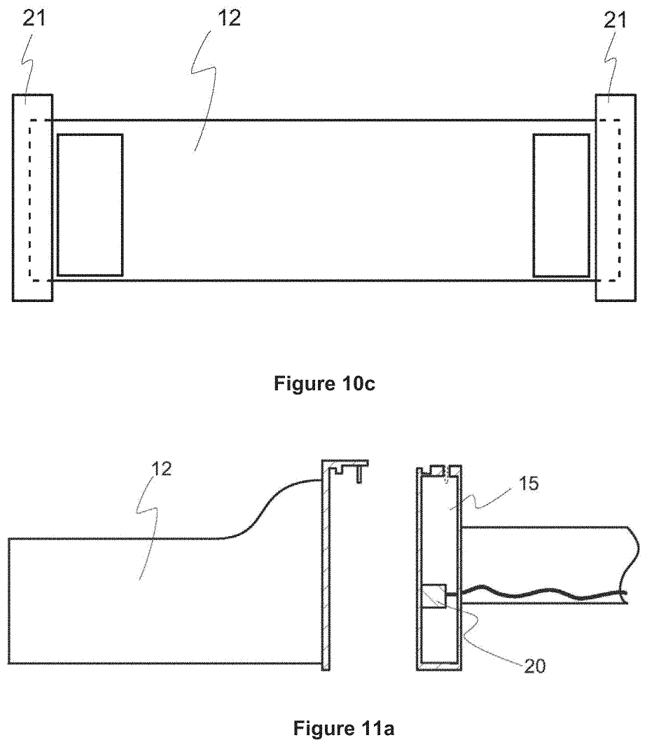

An alternative embodiment of a fastening region of a lifting tool 12 at the handling device 9 is shown in FIGS. 10a-10c. The webs, notches, plungers, and cutouts of the embodiment in accordance with FIGS. 8a-8b are replaced in this embodiment with a protrusion directed to the front at the interface 15, a corresponding depression at the rear side of the crossbar of the lifting tool 12, and lateral holding clamps that are movably fastened to the interface 15 and can be placed laterally over the combined components of the lifting tool 12 and of the interface 15 to fix the relative position and to form a latching mechanism together with the corresponding contours of the protrusion and of the depression. The procedure to place down and pick up the prongs or a prong of the lifting tool can take place analogously to the procedure shown in FIGS. 9a-9c.

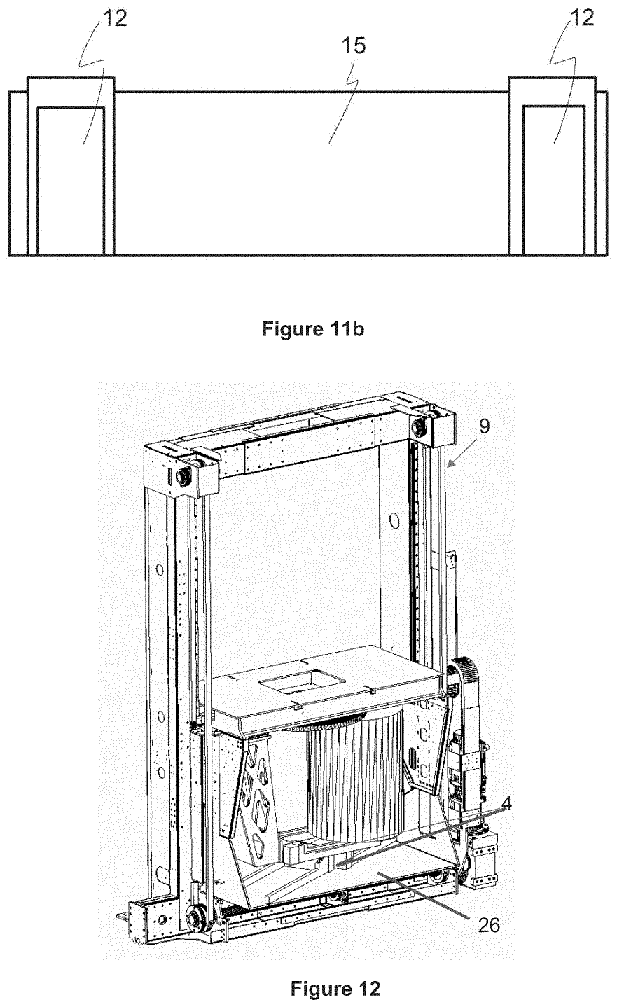

Finally, yet another embodiment of a fastening region of a lifting tool 12 at the handling device 9 is shown in FIGS. 11a-11b. This embodiment is suitable on a single fastening of fork prongs of a fork without a crossbar. Instead of a crossbar, the individual prongs of the lifting tool 12 each comprise a base plate that lies on the interface 15 of the handling device 9. A rearwardly projecting roof with downwardly projecting fastening pins that can engage in corresponding bores at the upper side of the interface 15 are formed at the upper side of the base plate. The latching device 21 is represented by an electromagnet arranged in the interface 15. The actuation device 20 supplies the electromagnet with power to close the latching device and stops the power supply to open the latching device. For this purpose, further sensors can be provided at the actuation device 20 that, for example, recognize the presence of lifting tool at the load receiver. The procedure to place down and pick up the prongs or a prong of the lifting tool can take place analogously to the procedure shown in FIGS. 9a-9c.

In accordance with an embodiment variant of the disclosure shown in FIG. 12, the lifting tools 4 are placed on a placement station 26 of the handling device 9. The releasable latching device of the handling device 9 is switched from a closed state into an open state and vice versa at this placement station. In an embodiment that is not shown, the oil pan of the handling device can serve as the placement station for the lifting tools to be changed. This embodiment may allow that a changing of the lifting tools can take place during a following position and thus at the same cycle time as the position change of the handling device.

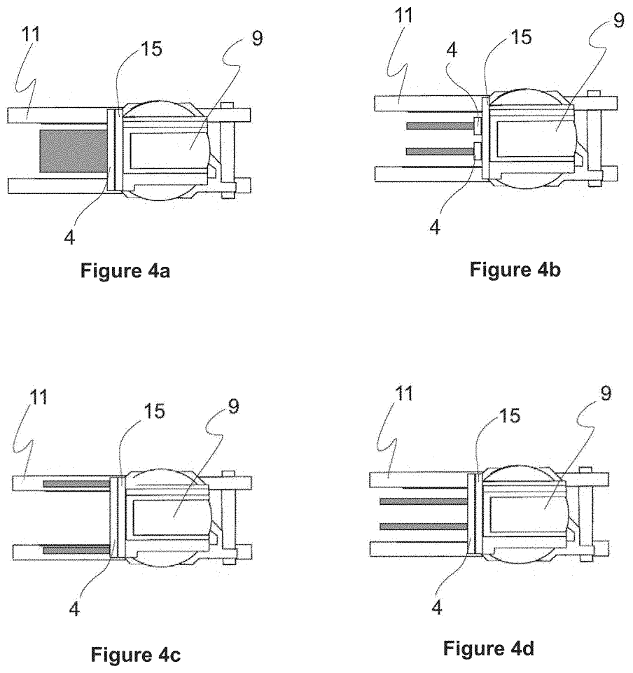

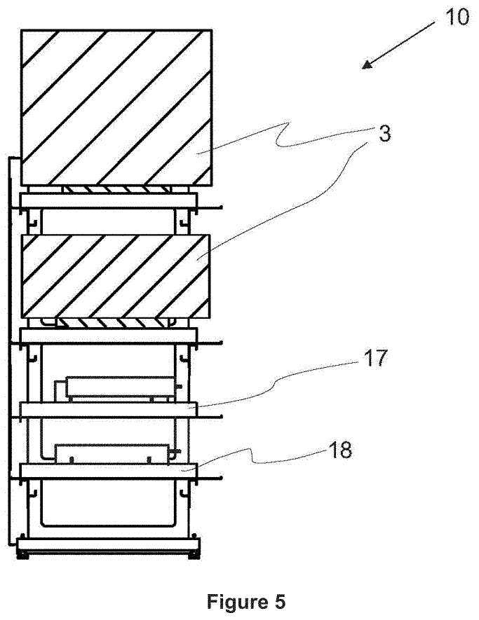

FIGS. 1-12 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

### REFERENCE NUMERAL LIST

1 . . . storage system and/or production system
2 . . . rack
3 . . . pallet of type A with workpiece or tool
4 . . . lifting tool of type A′
5 . . . setup station with storage space of the changing station
6 . . . setup station
7 . . . machine tool with storage space of the changing station
8 . . . machine tool
9 . . . handling device
10 . . . rack with storage space of the changing station
11 . . . floor rail for the handling device
12 . . . lifting tool
13 . . . pallet of type B with workpiece or tool
14 . . . lifting tool of type B′
15 . . . interface at the handling device
16 . . . independent changing station
17 . . . storage space of a changing station
18 . . . storage space of a changing station
19 . . . positioning aid
20 . . . actuation device
21 . . . latching mechanism
22 . . . rotatable stack arrangement
23 . . . pallet of type C with workpiece or tool
24 . . . lifting tool of type C′
25 . . . sensor array
26 . . . placement station for lifting tool

1. A storage system and/or production system having at least one handling device which is a rail-bound vehicle having a travel unit movable in a longitudinal direction of the system or a handling device fixed at a location with a travel unit movable about its own axis, a lifting unit of a stacker crane movable in a vertical direction, and a load receiving unit which can be movable and/or rotatable in a transverse direction, wherein the load receiving unit has an interface for fastening a lifting tool that is configured such that the lifting tool or a part of the lifting tool can be automatically changed or removed, with the handling device having a releasable latching device in whose closed state the lifting tool or its changeable part is secured against loss,
wherein
the storage system and/or production system or the handling device has at least one storage space or placement station for lifting tools; and
the releasable latching device of the handling device at a storage space or placement station can be displaced from a closed state into an open state and vice versa.

2. The storage system and/or production system in accordance with claim 1, wherein the at least one storage space of the handling device has an actuation device that displaces the latching device of the handling device from a closed state into an open state and vice versa.

3. The storage system and/or production system in accordance with claim 2, wherein the actuation device displaces the latching device mechanically, hydraulically, pneumatically, electrically, or in a combination of these action mechanisms from a closed state into an open state and vice versa.

4. The storage system and/or production system in accordance with claim 2, wherein the actuation device emits a signal to open and/or close the latching device of the handling device to a control of the handling device or to a higher ranking control.

5. The storage system and/or production system having at least one handling device and a storage space in accordance with claim 1, wherein the storage system and/or production system comprises at least two storage spaces.

6. The storage system and/or production system in accordance with claim 5, wherein the at least two storage spaces are present in a changing station.

7. The storage system and/or production system in accordance with claim 5, wherein the at least two storage spaces are integrated in components of the storage system and/or production system.

8. The storage system and/or production system in accordance with claim 5, wherein the at least two storage spaces have positioning aids for lifting tools placed thereon.

9. The storage system and/or production system in accordance with claim 5, wherein the at least two storage spaces have at least one sensor for recognizing an occupancy of the storage space by a lifting tool or a lifting tool part, a position of the lifting tool or of the lifting tool part at the storage space, and/or a kind of the lifting tool or lifting tool part located at the storage space.

10. The storage system and/or production system in accordance with claim 9, wherein the handling device has at least one sensor for determining a presence or the position of the lifting tool at a load receiver.

11. The storage system and/or production system in accordance with claim 1, wherein the handling device comprises two or more load receiving units each having at least one described interface or the load receiving unit comprises two or more interfaces as described.

12. The storage system in accordance with claim 7, wherein the storage space components are integrated in stacks or machines or setup stations.

13. The storage system in accordance with claim 8, wherein the storage spaces have center pins or rails as positioning aids.
